(19) United States
(12) Patent Application Publication
(10) Pub. No.: US 2003/0212763 A1
(43) Pub. Date: Nov. 13, 2003

(54) Distributed configuration-managed file synchronization systems

(76) Inventor: Ravi Kashyap, Sunnyvale, CA (US)

Correspondence Address: BLAKELY, SOKOLOFF, TAYLOR & ZAFMAN LLP, Seventh Floor, 12400 Wilshire Boulevard, Los Angeles, CA, 90025-1030, US

(21) Appl. No.: 10/143,313

(22) Filed: May 9, 2002

(51) Int. Cl. G06F 15/16

(52) U.S. Cl. 709/219

(57) ABSTRACT

Disclosed are novel methods and apparatus for file transfer solutions. In an embodiment, an apparatus is disclosed. The apparatus includes a hub and a spoke. The hub may have the capability of being coupled to other hubs at a plurality of remote sites. The spoke may be coupled to the hub and have a set of configuration parameters. The configuration parameters may be selected from a group including: a Vectorin vector to indicate ids for sites that send files to the spoke; a VectorOut vector to indicate ids for sites that receive files from the spoke; and a type field to indicate a type of the spoke.

### CROSS-REFERENCE TO RELATED APPLICATIONS

This application relates to application Ser. No. ______, entitled “Persistent Queuing For Distributed File Systems,” (Attorney Docket No. 5858P7410) and application Ser. No. ______, entitled “Delta Transfers in Distributed File Systems,” (Attorney Docket No. 5858P7711), both filed concurrently herewith and in the name of the present assignee. All these documents are hereby incorporated by reference for all purposes.

### FIELD OF INVENTION

The subject of this application relates generally to the field of data transfer. More particularly, an embodiment of the present invention relates to distributed configuration-managed file synchronization systems.

### BACKGROUND OF INVENTION

As the use of digital data becomes more prominent in everyday life, the need for access to reliable data sources increases. For example, a user may need regular access to data that can be physically located across different buildings or even around the world. This is often the case with respect to large company projects that may involve many groups worldwide working on a same solution.

As these types of joint projects become more commonplace, so does the need for having access to such data in real-time. In other words, the data accessed by each remote site will need to be current whether that data is stored locally or halfway around the world. Accordingly, the users need to have access to the latest version of the data as soon as it is released into the system from any site.

In many current implementations utilizing transmission control protocol/Internet protocol (TCP/IP), file transfer protocol (FTP), and other similar facilities (e.g., RSYNC command provided in Unix systems) are utilized to maintain data amongst remote sites. These tools, however, are generally useful only for transferring files from one point to the next. Moreover, automation of these tools only results in synchronization among multiple sites when a batch update or a nightly synchronization is performed. Also, if one of the remote sites goes down or cannot accept external data, the data may be dropped and unavailable.

### SUMMARY OF INVENTION

The present invention, which may be implemented utilizing a general-purpose digital computer, includes novel methods and apparatus to provide file transfer systems that can provide ready access to data among remote users. In an embodiment, an apparatus is disclosed. The apparatus includes a hub and a spoke. The hub may have the capability of being coupled to other hubs at a plurality of remote sites. The spoke may be coupled to the hub and have a set of configuration parameters. The configuration parameters may be selected from a group including: a VectorIn vector to indicate ids for sites that send files to the spoke; a VectorOut vector to indicate ids for sites that receive files from the spoke; and a type field to indicate a type of the spoke.

In another embodiment, the apparatus provides automatic data synchronization among the plurality of remote sites.

In a different embodiment, the type of the spoke is selected from a group comprising a hub and a spoke.

In a further embodiment, the type field is selected from a group comprising a pass-through and a store-n-go.

### DESCRIPTION OF DRAWINGS

The present invention may be better understood and its numerous objects, features, and advantages made apparent to those skilled in the art by reference to the accompanying drawings. These drawings, however, should not be taken to limit the invention to the specific embodiments, but are for explanation and understanding only.

FIG. 1 illustrates an exemplary computer system 100 in which the present invention may be embodied;

FIG. 2 illustrates an exemplary network configuration 200 in accordance with an embodiment of a present invention;

FIG. 3 illustrates an exemplary network configuration 300 in accordance with an embodiment of a present invention;

FIG. 4 illustrates an exemplary network configuration 400 in accordance with an embodiment of a present invention;

FIG. 5 illustrates an exemplary network configuration 500 in accordance with an embodiment of a present invention; and

FIG. 6 illustrates an exemplary communication system 600 in accordance with an embodiment of a present invention.

The use of the same reference symbols in different drawings indicates similiar or identical items.

### DETAILED DESCRIPTION

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

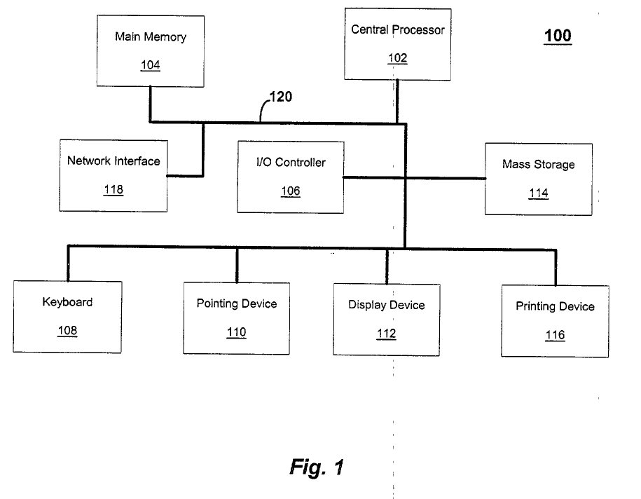

FIG. 1 illustrates an exemplary computer system 100 in which the present invention may be embodied in certain embodiments. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., hard disk, optical drive, or the like), and a network interface 118. Additional input/output devices, such as a printing device 116, may be included in the system 100 as desired. As illustrated, the various components of the system 100 communicate through a system bus 120 or similar architecture.

In an embodiment, the computer system 100 includes a Sun Microsystems computer utilizing a SPARC microprocessor available from several vendors (including Sun Microsystems of Palo Alto, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments, the network interface 118 can be implemented in Ethernet, Fast Ethernet, wide-area network (WAN), leased line (such as T1, T3, optical carrier 3 (OC3), and the like), digital subscriber line (DSL and its varieties such as high bit-rate DSL (HDSL), integrated services digital network DSL (IDSL), and the like), time division multiplexing (TDM), asynchronous transfer mode (ATM), satellite, cable modem, and FireWire.

Moreover, the computer system 100 may utilize operating systems such as Solaris, Windows (and its varieties such as NT, 2000, XP, ME, and the like), HP-UX, IBM-AIX, Unix, Berkeley software distribution (BSD) Unix, Linux, Apple Unix (AUX), and the like. Also, it is envisioned that in certain embodiments, the computer system 100 is a general purpose computer capable of running any number of applications such as those available from companies including Oracle, Siebel, Unisys, Microsoft, and the like.

It is envisioned that the present invention may be applied to systems, which utilize a revision control system (RCS) and meta data information, individually or in combination. The RCS can be configured as a backend storage system including the actual files. It is envisioned that RCS may be hidden from users. The meta data information can include data about the actual files. The meta data may be stored in a database, such as that provided by Sybase, Inc., of Emeryville, Calif. The meta data may include relational information, block and sector information, file type, and the like.

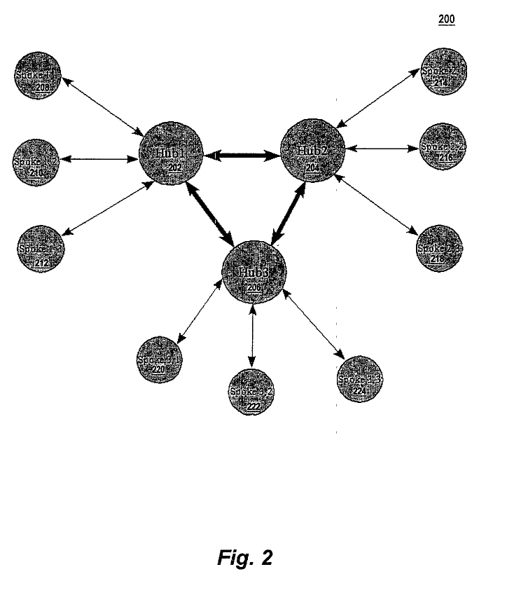

FIG. 2 illustrates an exemplary network configuration 200 in accordance with an embodiment of a present invention. As illustrated, the network configuration 200 includes three hubs (Hub1 202, Hub2 204, and Hub3 206) as an example. The hubs may be configured to communicate with each other through any number of networking tools including a point-to-point connection. Each of these hubs may have their own spokes. For example, Hub1 202 may have spokes 208, 210, and 212. Similarly, Hub2 204 may have spokes 214-218 and Hub3 may have spokes 220-224. All spokes on a single site may be grouped together to form a local subnet (e.g., with one hub and multiple spokes). Each remote site may be connected in a star topology (e.g., with the hub at the center of the star).

Each spoke may have a set of configuration parameters defined in a local or remote database. When the spoke is brought up, the spoke may utilize the configuration parameters to configure itself or auto-configure. Accordingly, each site may be easily reconfigured by, for example, changing the entries in the database that contains the configuration data for each site. Each spoke (208-224, for example) can have the following configuration parameters defined, in addition to any already existing ones:

1. VectorIn: a vector that contains the list of Ids for sites (siteIds) that send files to the spoke;

2. VectorOut: a vector that contains the list of siteIds that receive files from the spoke; and/or

3. Pass through or Store-n-go field: this field indicates to the spoke whether that spoke is just a connector or a hub (for example, with a buffer and no central directory) or a spoke (which, for example, makes a copy of the file it is transferring into the spoke's central directory).

Depending on the above parameters, each spoke can then become a hub or a spoke. Furthermore, in an embodiment, all hubs need not be in pass-through mode, and all spokes may be in store-n-go mode. For example, on a site, if there is a single spoke, it is unnecessary to add another hub on the same site. The only spoke can then act as a hub in store-n-go mode. So, each site may be configured as per the requirements at that site. In an embodiment, some of the advantages of such an architecture are that each site only transfers the file once to the other sites, but not to each spoke. This reduces network traffic. Also, such architecture is very scalable, and is highly flexible to accommodate different configurations at each site.

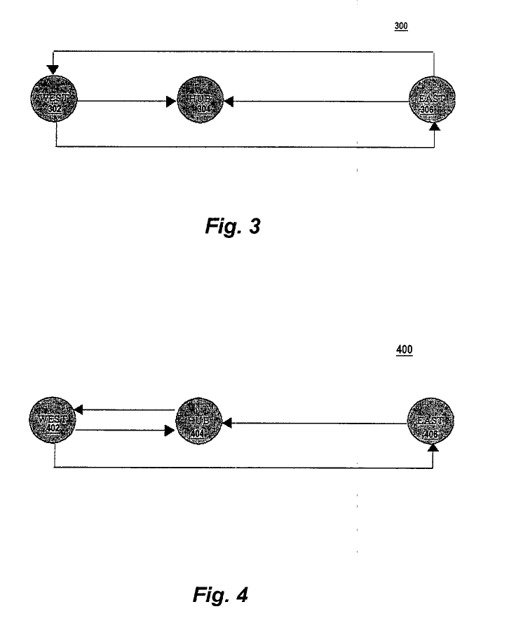

FIG. 3 illustrates an exemplary network configuration 300 in accordance with an embodiment of a present invention. The network configuration 300 includes a West spoke 302, a hub 304, and an East spoke 306. In accordance with an embodiment of the present invention, the hub 304 is located proximate to the West spoke 302. The direction of the arrows in FIG. 3 indicates the direction of file transfer amongst the different nodes (302-306). As illustrated, the West and East spokes (302 and 306, respectively) can communicated bi-directionally, whereas the hub 304 only receives data from the West and East spokes (302 and 306, respectively) without transmitting any data. Accordingly, the network configuration 300 requires both the West and East spokes to transmit their data twice (i.e., once to each other and once to the hub 304). In such a configuration, the hub 304 may act as a warm backup storage for either the West or East spokes (302 and 306, respectively) and stores up-to-date date for quick switch over in case of user-spoke breakdowns, for example.

FIG. 4 illustrates an exemplary network configuration 400 in accordance with an embodiment of a present invention. The network configuration 400 includes a West spoke 402, a hub 404, and an East spoke 406. In accordance with an embodiment of the present invention, the hub 404 is located proximate to the West spoke 402. The direction of the arrows in FIG. 4 indicates the direction of file transfer amongst the different nodes (402-406). As illustrated, the West spoke 402 and the hub 404 can communicated bi-directionally, whereas the East spoke 406 can only send data to the hub 404 and receive data from the West spoke 402.

In accordance with an embodiment of the present invention, one reason such a configuration is selected for FIG. 4 is that user data may only reside in the East and West spokes (406 and 402, respectively). The hub 404 may have no users and as a result may not generate any data itself. Also, such a configuration limits multiple transfers across domains. So, the East spoke 406 may transfer a file only once to the hub 404, and the hub 404 would store the transferred file locally as well as transfer it to the West spoke 402.

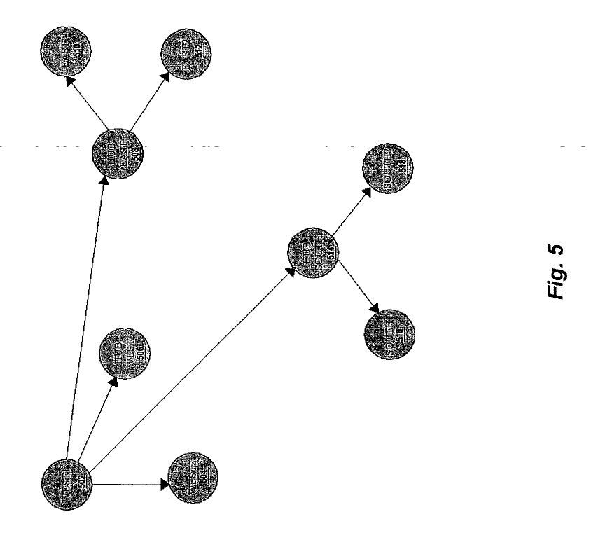

FIG. 5 illustrates an exemplary network configuration 500 in accordance with an embodiment of a present invention. The network configuration 500 includes three domains with multiple spokes in each. The West domain includes spokes 502 and 504, and a hub 506. The East domain includes a hub 508 and spokes 510 and 512. Similarly, the South domain includes a hub 514 and spokes 516 and 518. It is envisioned that the direction of the arrows in FIG. 5 illustrates a transfer for a file that originates from spoke 502.

In particular, within the West domain, the spoke 502 (West1) transfers the file itself. Namely, the file is transferred to the spoke 504 (West2) and the hub 506 (Hub West) directly. The spoke 502 also transfers a copy of the file to the hubs on the remaining domains (508 and 514). On the remote domains (East and South), the hubs can transfer the file to all the local spokes (510, 512, 516, and 518). A similar implementation can be performed for any spoke on any domain. In this fashion, only one copy of a file is transferred to a domain hub, and the network contention is reduced.

In some embodiments, it is envisioned that hubs may not have users working on them. So, no new files may be created on such hubs. In case a hub hosts users, that hub may be configured similar to a spoke. For example, that hub can transfer the given file locally to all spokes, and transfer a copy to each of the remote hubs.

It is envisioned that a hub may differentiate between the local-domain generated file and the file that it received from a foreign domain. In one embodiment, the receiving entity (or module), for example upon receiving a file, can check to see if the origin site of the file is the same domain as the hub. If so, the file does not need to be routed any further and can be just locally copied. On the other hand, if the domain of the origin site is different, the hub knows that it has to transfer a copy of the file to each of the local spokes.

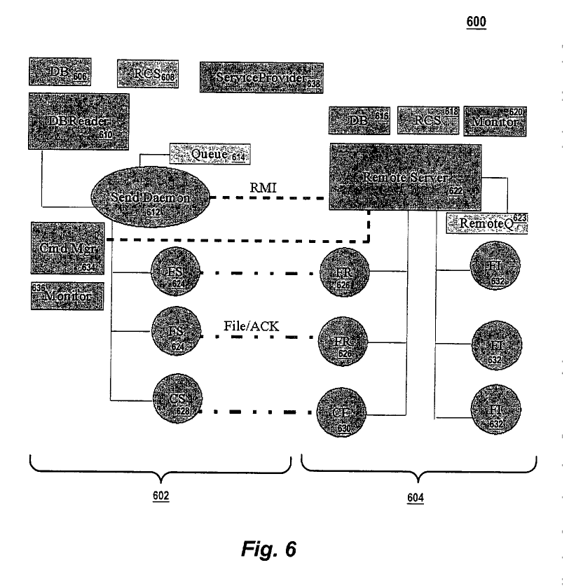

It is also envisioned that this checking may be performed by, for example, employing a FileReceiver module. The FileReceiver module can receive files and may run as a thread on a general-purpose computer or an appropriate networking device. The FileReceiver upon receiving a file may: (1) ensure that the received file is accurate (for example, by performing checksum validations) and/or (2) check the file origin (and if the file is foreign, the FileReceiver can route the received file locally). In an embodiment, the step (2) above can be done by the FileReceiver present on a hub rather than on a spoke. In an embodiment, if the FileReceiver module has to route the file, the FileReceiver module can insert entries into, for example, a transfer table in a database (e.g. locally). In one embodiment, there can be one entry per each local spoke in the database. Another process, e.g., a database reader (DBReader such as that discussed with respect to FIG. 6), can then handle additional work for transferring the file.

Accordingly, the routing information can be stored in a database. In an embodiment, with the above-proposed architecture, each hub may know which domain it belongs to, and what spokes exist on its local domain. Also, each spoke may know to which other spokes and hubs is it directly connected. For example, an entry in a transfer table can be inserted for each spoke and/or hub that the given local spoke is directly connected to. In certain embodiments, the DBReader module on the local spoke can then handle or initiate the transfers.

FIG. 6 illustrates an exemplary communication system 600 in accordance with an embodiment of a present invention. The communication system 600 includes a sender site 602 and a receiver site 604. The sender site 602 includes a database 606 (DB), an RCS 608, a DBReader module 610, and a send daemon 612. It is envisioned that the database 606 may store meta data and other data as required. The RCS may be hidden from users and store actual files being transferred and/or maintained on the sender site 602. The DBReader module 610 can be a process that may run on a computer system (such as that discussed with respect to FIG. 1). In certain embodiments, the DBReader module 610 may be run on a multitasking system as a process, for example. The DBReader module 610 may run on a system continuously. It is envisioned that the DBReader module 610 has access to the database 606 and the RCS 608, and can process the stored data. The DBReader module 610 may initiate a file transfer process by, for example, reading a job description from a transfer table stored in, for example, the database 606.

In an embodiment, the DBReader module 610 may further communicate with the send daemon 612. It is envisioned that the send daemon 612 can be responsible for sending data from the sender site 602 to the receiver site 604. The send daemon 612 can be a Unix daemon thread or other similarly configured process running on a computer system. The send daemon 612 may be configured to run in the background so it can be activated with short notice. In one embodiment, the send daemon 612 may be a thread spawned from the DBReader module 610. The send daemon 612 may have access to a queue 614 (internal or external to the send daemon 612). The queue 614 may provide storage capabilities to the send daemon 612. It is envisioned that the queue 614 may be any type of storage such as random access memory (RAM), its varieties such as dynamic RAM (DRAM), static RAM (SRAM), synchronous DRAM (SDRAM), and the like. Moreover, the queue 614 may provide one or more of the following: storage for unsent jobs and arrange pending job descriptions according to their priority (first-come, first-serve (FCFS) for jobs with no or same priority). The queue 614 may be implemented utilizing Java in certain embodiments.

The receiver site 604 includes a database 616, an RCS 618, a monitor 620, and a remote server 622. The database 616 and RCS 618 may be similar to those of the sender site 602 (i.e., database 606 and RCS 608). The monitor 620 can be on lookout for information of interest and inform a selected party (e.g., a user) about the status of the information desired. For example, the monitor 620 may be a visual aid indicating status of a transfer in real-time. The remote server 622 can have access to the database 616, RCS 618, and monitor 620. The remote server 622 may also have access to a remoteq 623. The remoteq 623 may be a similar device such as that discussed with respect to the queue 614. The remoteq 623 can provide the remote server 622 with storage capabilities. It is envisioned that the remoteq 623 may store meta data for the receiver site 604. Also, the remoteq 623 may provide memory for delivered job descriptions which are uninstalled.

The sender site 602 can also include one or more file sender/s 624 which may communicate with one or more, respective, file receiver/s 626. This communication may also utilize acknowledge capabilities to ensure a file is properly transferred. Other error correction capabilities may also be used to ensure proper communication between the file senders 624 and file receivers 626. Such error correction capabilities may include parity checking, MD-5 checksum validation, and the like. The file senders 624 may hold all information about the file that is being transferred. Further, it is envisioned that the file sender 624 may perform one or more of the following: physically transfer a file from the sender site 602 to the receiver site 604, obtain acknowledgment regarding the transfer, update a ReceivedTime field (indicating when the data sent was received), for example, in the transfer table that may be stored in the database 606. The file sender 624 can be a thread spawned by the send daemon 612.

The file receiver 626 may be responsible for one or more of the following tasks: receiving files over, for example, a TCP socket, re-calculating the checksum, verifying file correctness, copying the file into the designated buffer area, sending an ACK/NAK signal (to acknowledge receipt or non-receipt), remove the current entry (or row) from queue of the remote server 622, and update the file receiver count at the remote server 622. In some embodiments, the file receiver 626 may be a thread spawned by a remote server routine.

The sender site 602 can additionally include a command sender 628 for sending commands from the sender site 602 to a command executor (CE) 630 on the receiver site 604. It is envisioned that the command sender 628 may perform one or more of the following: start a server socket, wait for the acknowledgment from the command executor 630, and update the appropriate database (such as the database 616). Moreover, the command sender 628 may be a thread spawned by the remote server 622. Furthermore, the command executor 630 may perform one or more of the following: connect to the command sender 628, execute the command (e.g., copy data, delete data, and/or delete directory), send acknowledgment, and update information about when an action is done in an appropriate database (such as the database 616). Moreover, the command executor 630 may be a thread spawned by the remote server 622.

In an embodiment, the sender site 602 can include a command manager (Cmd Mgr) 634 and a monitor 636. The monitor 636 may be similar to that discussed with respect to the receiver site 604 (i.e., the monitor 620). The command manager 634 is envisioned to be able to communicate (directly or indirectly) with the remote server 622 and to execute commands. Such commands may, for example, include push data and pull data, which can be used to change the priority on a file that is being transferred, so that it is shipped ahead of or after the rest (or select ones) of the current queue members.

The receiver site 604 can further include one or more file installer/s 632. The file receivers 632 may perform one or more of the following: verify whether meta data of predecessor and object being installed are in place, verify whether the RCS 618 of predecessor is in place, install the object into the RCS 618, update object's meta data, send acknowledgment as required, update flags including CompleteTime (indicating the time the installation was complete) and Installation Message (any messages resulting from the installation) on, for example, a source database (where the file being installed is located), and delete any unused buffer files utilized for the installation. It is envisioned that the file installer 632 may be a thread spawned by the remote server 622.

It is also envisioned that the send daemon 612 may perform one or more of the following: perform handshake operations between the sender and receiver sites, initiate a file transfer or a command execution, execute a remote method invocation (RMI) call on the remote server 622, transfer job description, request/provide a port number, spawn a file sender (such as 624) along with passing relevant port information, spawn a command sender (such as 628), wait on the queue 614 for more jobs, and keep a balance in the number of existing transport channels. Further, the remote server 622 may provide remote methods to the send daemon 612 to initiate a file transfer or a command execution. The remote server 622 may also keep an account on file receiver/file installer counts, spawn the file receivers 626 to receive files, and spawn file installers 632 when the remoteq 623 receives a new member.

The communication system 600 may further include a service provider 638. The service provider 638 may provide a variety of services to the system components including one or more of the following: handling periodic registrations from key modules, subscribing and unsubscribing of available monitoring services, routing the monitor messages to the corresponding monitors, and providing a pointer to, the correct log file for remote modules. It is envisioned that one service provider 638 is sufficient for the entire system. In an embodiment, the service provider 638 may run on a primary site.

Also, the communication system 600 may further include a database manager module (not shown), which may provide useful application programming interfaces (APIs) to, for example, insert, update, delete, and select information on various tables in the databases present in the communication system 600. Such a database manager may be implemented as a Java object.

It is envisioned that an interface between a user command and transparent transport layer may be a database. More specifically, this interface may be a transfer table. Such a transfer table may store the required information about each file transfer. Each user command, after successful completion, may in turn deposit a transfer request into the transfer table. Furthermore, it is envisioned that the DB Reader 610 may be present on all sites where there is a possibility of users checking in files. The DB Reader 610 having sensed what needs to be transferred can buffer the jobs into the respective queues of the destinations. It also can spawn the send daemon 612, for each destination and from then on, it may hand over the corresponding queue to it. The send daemon 612 may then handle the handshake between itself and the remote server 622, and establish full-duplex communication channels for example, to transfer files and receive acknowledgments. This may involve creation of file sender-file receiver pairs (624 and 626, respectively) on sender and receiver sites, respectively. If the command is other than create or save data, the command sender 628 and command executor 630 pairs may be created.

The file sender 624 can transfer a file, and the checksum of that file over the established channel, and wait for the acknowledgment from the file receiver 626. The file receiver 626 having received the file, may perform a checksum verification between the received checksum, and the re-calculated checksum on the receiver site 604. If they tally, a positive ACK maybe sent to the file sender 624. Otherwise, a NAK may be sent. Upon receiving an ACK, the file sender 624 may update the ReceivedTime in, for example, the transfer table and exit. On receiving a NAK, the file sender 624 may re-transfer the file. The iteration may be continued until a positive ACK is received, or once the file sender 624 times out. If the file sender 624 times out, it may enter a panic state, and send out e-mails to an appropriate target (such as a system administrator).

Once a file is received correctly, the file receiver 626 may copy the file to its designated buffer area, and enter the job description into the remoteq 623, and also register the job in an appropriate (e.g., remoteq) table in the database 616. In case of the remote server 622 break down, the remoteq 623 may rebuild the required information from the database 616. In such a case, the remote server 622 may start a FileInstaller thread for each file received (such as file installer 632). The FileInstaller can be responsible for the installation of the file in the RCS 618, and for updating a VersionHere bit in a FileVersions table in the database 616. The FileInstaller may perform a series of checks for the presence of both the predecessor's and the file's meta-data, and also the RCS version of the predecessor. Upon having verified all the dependencies, the file may be checked into the RCS 618. Then the FileVersions, TransferConfirm, and RemoteQ tables may be notified of the successful installation, and the CompleteTime and Installation Message entries (or columns) may be set on the source database, i.e., the database on the site where the file originated. This process may complete the file transfer procedure in accordance with an embodiment of the present invention.

The above procedure may be applied where the command is either create or save data. If the command is one of delete data, delete directory, or copy data, a command sender (such as the command sender 628) may be started instead of the file sender 624. The command sender 628 may then wait for the ACK from the corresponding command executor 630. Having received the ACK/NAK, the acknowledgment may be recorded in the database 616, and a panic mail may be sent in case of NAK. In case of delete data or delete directory, a deletor thread may be spawned, for example, as a part of the command sender 628. This thread may wait for the positive acknowledgments from all the sites, for example, from its VectorOut. Having received them, the deletor thread can delete the RCS files from the local central directory, and then clean the meta-data on its site. This process may replicate to other sites, through meta-data replication, for example.

Accordingly, certain embodiments of the present invention address the problems associated with keeping live data on a particular site, spoke, or a domain, in sync with the data on multiple remote spokes in real-time. In a user community distributed across a country or anywhere in the globe, the need arises to have select data be available on any site at any time. Embodiments of the present invention provide users access to the latest version of the data as soon as it is released into the system from any site. Therefore, there should not be a need to wait for the new data until there is a batch update or a nightly synchronization, for example.

Also, if one of the remote sites is down or cannot accept external data, the systems provided in accordance with some embodiments of the present invention can temporarily store (e.g., buffer or queue) the new data until the remote spoke is back online. Further, the system can work with the configuration control mechanisms (CCM) on each site and can install the new data into the CCM on the remote sites. Additionally, the system can work with meta data (if any) in, for example, the backend database storage, so that the user commands or interfaces to the database function accurately during any synchronization process.

The foregoing description has been directed to specific embodiments. It will be apparent to those with ordinary skill in the art that modifications may be made to the described embodiments, with the attainment of all or some of the advantages. For example, the schemes, data structures, and methods described herein can also be extended to other applications. More specifically, any type of data may be transferred utilizing embodiments of the present invention. Also, the transfer systems provisioned in accordance with embodiments of the present invention may be configured depending on a specific project, data types, number of users, size of files, location of users, and the like. Further, the routines described herein may be implemented utilizing Java programming techniques. Therefore, it is the object of the appended claims to cover all such variations and modifications as come within the spirit and scope of the invention.

What is claimed is:

1. A communication system comprising:
a sender site, the sender site including a database and a file sender;
a receiver site including a database, a file installer, and a file receiver, the file installer installing a file sent by the file sender and received by the file receiver in the receiver site database; and
a communication channel coupled to the file sender and the file receiver to transfer the file from the sender site to the receiver site,
wherein data from the sender site is also kept on the receiver site in a substantially real-time manner.

2. The communication system of claim 1 wherein the sender site further includes a database reader to access information stored in the sender site database.

3. The communication system of claim 2 wherein the database reader further spawns a plurality of processes to transfer the file.

4. The communication system of claim 2 wherein the processes are selected from a group comprising the file sender and a command sender.

5. The communication system of claim 1 wherein the receiver site further includes a remote server to access information stored in the receiver site database.

6. The communication system of claim 5 wherein the remote server further spawns a plurality of processes to transfer the file.

7. The communication system of claim 6 wherein the processes are selected from a group comprising the file receiver and a command executor.

8. The communication system of claim 1 further including a service provider to provide at least one service selected from a group comprising handling periodic registrations from key modules in the communication system, subscribing and unsubscribing of available monitoring services, routing a monitor message to a corresponding monitor module, and providing a pointer to a correct log file for remotely located modules.

9. The communication system of claim 1 further including an RCS for at least one of the sender site and the receiver site.

10. The communication system of claim 1 wherein the sender site further includes a send daemon to transfer the file.

11. The communication system of claim 1 wherein the sender site further includes a command manager to execute commands.

12. The communication system of claim 1 wherein the sender site and the receiver site are configured in a hub and spoke network.

13. An apparatus for providing automatic data synchronization among a plurality of remote sites, the apparatus comprising:
a hub, the hub having a capability of being coupled to other hubs at the plurality of remote sites; and
a spoke coupled to the hub, the spoke having a set of configuration parameters, the configuration parameters being selected from a group including:
a VectorIn vector to indicate ids for sites that send files to the spoke;
a VectorOut vector to indicate ids for sites that receive files from the spoke; and
a type field to indicate a type of the spoke.

14. The apparatus of claim 13 wherein the type of the spoke is selected from a group comprising a hub and a spoke.

15. The apparatus of claim 13 wherein the type field is selected from a group comprising a pass-through and a store-n-go.

16. The apparatus of claim 13 wherein the hub and spoke form a star topology.

17. A method of synchronizing data on remote sites, the method comprising:
providing a sender site, the sender site including a database and a file sender;
providing a receiver site including a database, a file installer, and a file receiver, the file installer installing a file sent by the file sender and received by the file receiver in the receiver site database; and
providing a communication channel coupled to the file sender and the file receiver to transfer the file from the sender site to the receiver site,
wherein data from the sender site is also kept on the receiver site in a substantially real-time manner.

18. The method of claim 17 wherein the sender site further includes a database reader to access information stored in the sender site database.

19. The method of claim 17 wherein the receiver site further includes a remote server to access information stored in the receiver site database.

20. The method of claim 17 further including providing a service provider on at least one of the sender or receiver sites.

21. The method of claim 17 wherein the service provider provides at least one service selected from a group comprising handling periodic registrations from key modules in the communication system, subscribing and unsubscribing of available monitoring services, routing a monitor message to a corresponding monitor module, and providing a pointer to a correct log file for remotely located modules.

22. The method of claim 17 further including providing an RCS for at least one of the sender site and the receiver site.

23. The method of claim 17 wherein the sender site further includes a command manager to execute commands.

24. An apparatus comprising:
a sender site, the sender site including a database and a file sender means;
a receiver site including a database, a file installer means, and a file receiver means; and
a communication means coupled to the file sender means and the file receiver means to transfer a file from the sender site to the receiver site.
means

25. The apparatus of claim 24 further including an RCS for at least one of the sender site and the receiver site.

26. An article of manufacture comprising:
a machine readable medium that provides instructions that, if executed by a machine, will cause the machine to perform operations including:
providing a sender site, the sender site including a database and a file sender;
providing a receiver site including a database, a file installer, and a file receiver, the file installer installing a file sent by the file sender and received by the file receiver in the receiver site database; and
providing a communication channel coupled to the file sender and the file receiver to transfer the file from the sender site to the receiver site,
wherein data from the sender site is also kept on the receiver site in a substantially real-time manner.

27. The article of claim 26 wherein the sender site further includes a command manager to execute commands.

28. The article of claim 26 wherein the operations further include providing a service provider on at least one of the sender or receiver sites.

29. The article of claim 28 wherein the service provider provides at least one service selected from a group comprising handling periodic registrations from key modules in the communication system, subscribing and unsubscribing of available monitoring services, routing a monitor message to a corresponding monitor module, and providing a pointer to a correct log file for remotely located modules.

30. The article of claim 26 wherein the operations further include providing an RCS for at least one of the sender site and the receiver site.
